(19) United States
(12) Patent Application Publication
(10) Pub. No.: US 2006/0170564 A1
(43) Pub. Date: Aug. 3, 2006

(54) Device for controlling electronic apparatuses

(75) Inventors: Andras Montvay, Stuttgart (DE); Karin Klabunde, Bochum (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N. V., Eindhoven (NL)

(21) Appl. No.: 10/549,351

(22) PCT Filed: Mar. 8, 2004
(86) PCT No.: PCT/IB04/00758

§ 371 Date: Sep. 14, 2005

(30) Foreign Application Priority Data
Mar. 19, 2003 (EP) 03100700.8

(51) Int. Cl. G05B 19/02

(52) U.S. Cl. 340/825.24; 340/825.69

(57) ABSTRACT

The invention relates to a central control unit (4) for a series of electronic apparatuses such as, for example, a CD player (1), a video recorder (2) or a satellite receiver (3). The electronic apparatuses are connected via a SCART cable to connections (5) of the central control unit (4). The central control unit (4) further comprises interfaces (6a, 6b) to mobile control apparatuses such as a PDA (8) or a PC (7), in which further external control apparatuses such as, for example, a mobile phone (9) can be connected via a network (12). The central control unit (4) translates protocols used for the connections (5) and the interfaces (6a, 6b) and thus provides the possibility of a flexible control of the electronic apparatuses (1, 2, 3).

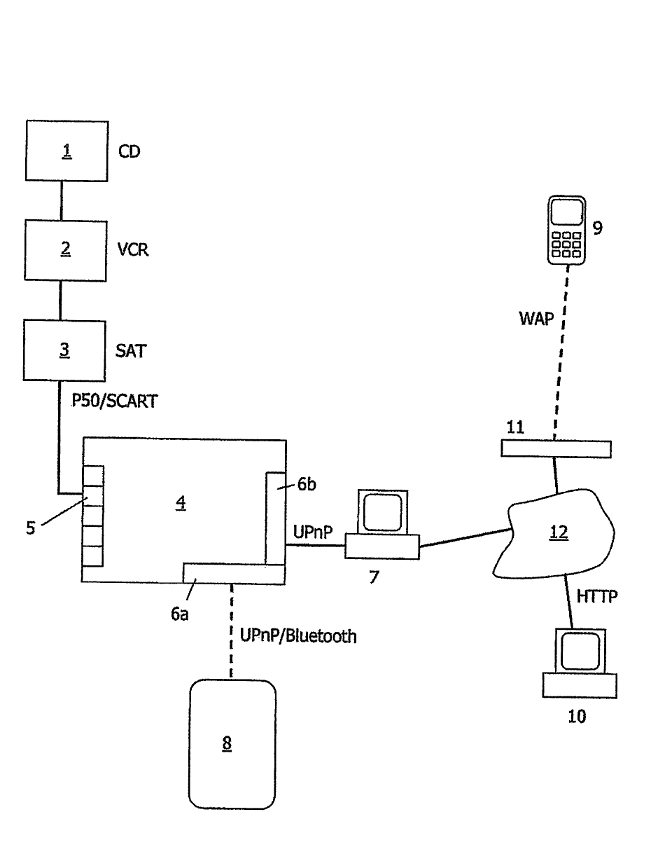

The invention relates to a central control unit for electronic apparatuses in the field of consumer electronics (CE), as well as to a network formed from such apparatuses, the central control unit and external control apparatuses.

Existing electronic apparatuses in the field of consumer electronics customarily comprise operating elements directly on the apparatus or have a remote control which operates with infrared signals. They have the drawback that the user should always be in the proximity of these devices for operating the apparatus and that he has to adhere to operating procedures that are especially valid for the relevant apparatus.

To simplify the control of a plurality of electronic apparatuses, a central control unit is known from WO 99/29045, which may be integrated in, for example, a television and is coupled via different SCART connections to electronic apparatuses such as, for example, a video recorder or satellite receivers. Furthermore, the control unit comprises a receiver for signals from an infrared remote control such as an IR transmitter, which can transmit commands to the IR interfaces of the connected apparatuses. Via the control of the electronic apparatuses by means of IR signals and the observed feedback to the SCART connections, the control unit can determine which apparatuses are currently active. It can then utilize its IR transmitter so as to pass on the commands, predetermined by the IR remote control, to the apparatuses. This system has the drawback that it requires the use of IR signals and consequently requires a spatial proximity of all apparatuses.

It is an object of the invention to provide means for a uniform control of different electronic apparatuses in which the electronic apparatus and the associated control apparatus may be present at different locations. Furthermore, it should be possible to preferably use known electronic apparatuses for the control.

This object is achieved by a central control unit having the characteristic features defined in claim 1 and by a network having the characteristic features defined in claim 10. Advantageous embodiments are defined in the dependent claims.

The central control unit according to the invention, used for electronic apparatuses such as, for example, a video recorder, a television, a CD or DVD player, a satellite receiver or the like comprises connections for control lines to said electronic apparatuses. It also comprises at least one interface for coupling an external control apparatus having a user interface for operation by a user. The central control unit is adapted to couple communication protocols for the connections to the electronic apparatuses, on the one hand, as well as for the interface or interfaces to the external control apparatuses, on the other hand, so as to provide the possibility of controlling the electronic apparatuses by means of the at least one control apparatus.

The central control unit described provides great flexibility in the management of different electronic apparatuses, because it accesses the apparatuses via control lines and adapts the conventional protocols used on the control lines to external control apparatuses. As will be apparent from the embodiments of the invention described in greater detail hereinafter, this allows the use of a wide variety of applicable control apparatuses. More particularly, it is not necessary for the control apparatus and the electronic apparatus to be both within the range of IR signals. Due to the wired connection of the electronic apparatuses, it is another advantage that particularly also apparatuses without any radio or IR interface as well as many analog apparatuses can be coupled to the central control unit.

According to a preferred embodiment of the invention, the connections for the electronic apparatuses are SCART connections. SCART or “Euro-AV” connections are plug and connection systems in accordance with the European standard for video and HiFi techniques, which simultaneously provide video signals, RGB signals, FBAS signals and audio signals on separate lines. Particularly, a reserved pin of the SCART cable may be used for the communication with distributed protocols such as “P50”.

The interface present on the central control unit may be particularly adapted for wireless communication with a control apparatus. This communication may be realized, for example, via infrared signals so as to allow use of a conventional remote control. Moreover, it may be realized via radio signals, which has the advantage of a greater flexibility as regards the distance between the central control unit and the control apparatus.

Furthermore, the interface may be adapted for connection to a network, in which the at least one control apparatus is in turn connected to the network. By connection to the network such as, for example, the Internet, a wide potential is offered as regards the control possibilities and the usable control apparatuses.

The control apparatus may be particularly a mobile computer (“handheld”) or a stationary computer (PC). The use of a computer as a control apparatus provides the possibility of using sophisticated software as user interface and thus enables the user to control the electronic apparatuses in a comfortable and far-reaching way. The control apparatus may be alternatively a mobile phone, so that the user has access to the electronic apparatuses quasi-everywhere.

The use of a computer as a control apparatus particularly provides the possibility of realizing an electronic program guide for a television and/or a video recorder on the control apparatus. When connecting the control apparatus to a network such as, for example, the Internet, the program guide can revert to information present on the Internet.

The central control unit is preferably adapted, after it has been switched on, to determine (active) electronic apparatuses connected to the connections, and their properties. In this way, the central control unit can set up an updated list of available electronic apparatuses with all their properties and, if necessary, make it available for an external control apparatus.

The central control unit may be realized as an independent apparatus. Optionally, it may, however, also be integrated in an electronic apparatus such as, for example, a video recorder and allow its control as well as the control of further electronic apparatuses which are coupled to the connections via connection cables. In a corresponding miniaturized realization of the device (for example, on a single chip), it may also be integrated in a connection cable.

The invention further relates to a network comprising electronic apparatuses and associated control apparatuses, wherein the electronic apparatuses are coupled to the control apparatuses via a central control unit of the type described hereinbefore. This means that the electronic apparatuses are connected to the connections of the central control unit via connection cables, while the central control unit communicates via its interfaces with the external control apparatuses and internally provides a translation between the communication protocols at the connections and the interfaces.

These and other aspects of the invention are apparent from and will be elucidated with reference to the embodiments described hereinafter.

In the drawing:

The sole FIGURE shows diagrammatically a network comprising a central control unit according to the invention.

As examples of controllable electronic apparatuses, the FIGURE shows diagrammatically a CD player 1, a video recorder 2 and a satellite receiver 3. These electronic apparatuses 1, 2, 3 are serially connected via a SCART cable to the connections 5 of a central control unit 4. Instead of being connected in a chain, as shown in the FIGURE, the electronic apparatuses 1, 2, 3 may also be coupled individually to the central control unit 4 via separate SCART cables. Furthermore, the electronic apparatuses 1, 2, 3 may also be connected via a chinch cable.

The central control unit 4 further has interfaces 6a, 6b via which external control apparatuses can communicate with the central control unit 4. Examples of control apparatuses shown in the FIGURE are:
A PDA 8 (Personal Digital Assistant) or WEB tablet which is connected via a protocol based on, for example, wireless radio standards such as “Bluetooth” or on Middleware standards such as, for example, UPnP (Universal Plug and Play). When the communication is realized via a UPnP protocol, a user interface may also be presented on the mobile apparatus 8.
A first PC 7 which is coupled, for example, via a UPnP protocol to the connection 6b of the central control unit 4. Via said connection, the PC 7 can access the services of the UPnP protocol from an application or a web page and thus offer the user at the PC 7 an operating interface to the controlled electronic apparatuses 1, 2, 3.
Via the PC 7, the central control unit 4 may also be connected indirectly to a network such as, for example, the Internet 12. The network 12 then provides further access possibilities, for example, via a Gateway 11, WAP and a mobile phone 9 or via HTTP to a further PC 10 on the Internet 12. A user interface may again be presented on said PC 10 or on the mobile phone 9. By using the Internet (WWW), for example, an electronic program guide may also be realized on the PC 10.

The central control unit 4 may represent an independent apparatus but may be alternatively integrated in one of the electronic apparatuses 1, 2, 3 or in the PC 7 (for example, by means of a plug-in card with a SCART connection). This does not change the logic structure of the image. When the central control unit 4 has a sufficiently small build, for example, on a single chip, it may principally also be integrated in a SCART plug so that no separate apparatus is required any longer.

A typical procedure when using the central control unit 4 in said network of electronic apparatuses 1, 2, 3 and control apparatuses 8-10 will be described hereinafter. It is assumed that all electronic apparatuses 1, 2, 3 can manage said P50 standard, which is widely used for consumer electronics apparatuses. The P50 standard describes the mutual control of analog apparatuses in accordance with an analog protocol. This protocol may be run on a reserved pin of a SCART cable or on a separate cable (chinch) and comprises a fixed quantity of commands.

After the central control unit 4 has been switched on, it initially finds out what kinds of apparatuses 1, 2, 3 are present in the P50 chain. To this end, it transmits the P50 message provided for this purpose without any operands and one after the other to all apparatus addresses and checks whether the relevant apparatus replies or does not reply by means of an “acknowledge” answer. Furthermore, the central control unit 4 can find out further information about the available apparatuses 1, 2, 3 via further P50 commands. It can particularly query the transmission list of an apparatus (“Start Preset Transfer”) as well as the timer options of a video recorder 2 (“Give Timer Options”). In the latter case, it gives, for example, information on whether characteristic features such as Long-Play, VPS (Video Program System) or the programming of a daily repeated timer are supported.

The central control unit 4 may further test given relevant characteristic features of the electronic apparatuses in that it queries these characteristic features by way of trial, whereupon the apparatus may reply by means of a “not supported” message.

The central control unit 4 accordingly attempts to gain information about the P50 chain of the apparatuses 1, 2, 3 via different ways and tries to combine all obtained information as well as possible to a map of the chain. In this case, it may have to substitute lacking information by assumptions that cannot lead to erroneous behavior of the system when it is used at a later stage.

In the next step, the apparatuses 1, 2, 3 found and their possibilities are presented in the UPnP network by using the UPnP Discovery Standard. Typically, the external control apparatuses such as PC 7, PDA 8, etc. will not be switched on constantly, so that no receiver is available for the UPnP Discovery offers at the instant when the central control unit 4, which is usually in permanent operation, is switched on.

However, when a control apparatus is connected to the UPnP network, it starts an active query for services which it requires for, for example, an application with an Electronic Program Guide (EPG). The central control unit 4 thereupon responds and replies to the query with its offers. Subsequently, the external control apparatus can indicate the available possibilities to a user.

When the user then selects, for example, a broadcast for which the video recorder 2 should be programmed, it is passed on to the central control unit 4 via the UPnP control protocol. The central control unit 4 translates the command into P50 protocol elements (for example, command “Set Timer”) and sends it to the video recorder 2 via the SCART or chinch connection cable.

The proposed system thus provides the possibility of versatile control of the electronic apparatuses 1, 2, 3, for example, from a PC 7, 10, a PDA 8 or from remote apparatuses such as an office PC 10 or a mobile phone 9. It also allows the realization of a universal remote control which does not operate on an IR basis. The provision of an operating interface on the PC provides the possibility of a multitude of applications such as, for example, an Internet-based electronic program guide for programming a video recorder.

In contrast to conventional techniques, the apparatuses 1, 2, 3 to be controlled do not need to be changed or replaced by extended apparatuses. It is a further advantage that particularly also analog apparatuses can be controlled.

The control apparatus used (PC, remote control, PDA, etc.) and the existing CE apparatuses 1, 2, 3 constitute an ad hoc system enabling a user to radically simplify complicated processes such as programming the video recorder. While a TV magazine, remote controls for the television and the video recorder as well as an elaborate and error-prone procedure for inputting commands via the remote controls has hitherto been necessary for programming a video recorder, the proposed invention substitutes this, for example, for a simple click on a hyperlink on a website, in an E-mail or an SMS message.

### LIST OF REFERENCE NUMERALS

1 CD player
2 video recorder
3 satellite receiver
4 central control unit
5 connections for electronic apparatuses
6a, 6b interfaces to control apparatuses
7 PC
8 PDA
9 mobile phone
10 PC
11 Gateway
12 Internet

1. A central control unit (4) for electronic apparatuses (1, 2, 3) having connections (5) for control lines to the electronic apparatuses (1, 2, 3) as well as at least one interface (6a, 6b) for coupling an external control apparatus (8, 9, 10) to a user interface, the central control unit (4) being adapted to couple the communication protocols for the connections (5) and for the interface (6a, 6b) so as to provide the possibility of controlling the electronic apparatuses by means of the at least one external control apparatus.

2. A central control unit as claimed in claim 1, characterized in that the electronic apparatuses comprise a video recorder (2), a television, a CD/DVD player (1) and/or a satellite receiver (3).

3. A central control unit as claimed in claim 1, characterized in that the connections are SCART connections (5) and/or chinch connections.

4. A central control unit as claimed in claim 1, characterized in that the at least one interface (6a) is adapted for wireless communication with the control apparatus (8, 9, 10).

5. A central control unit as claimed in claim 1, characterized in that the interface (6b) is adapted for connection to a network (12) to which at least one control apparatus (9, 10) is connected.

6. A central control unit as claimed in claim 1, characterized in that the control apparatus is a mobile (8) or stationary (10) computer and/or a mobile phone (9).

7. A central control unit as claimed in claim 1, characterized in that the control apparatus (8, 9, 10) comprises an electronic program guide for one of the electronic apparatuses.

8. A central control unit as claimed in claim 1, characterized in that the unit, after being switched on, is adapted to determine the electronic apparatuses (8, 9, 10) connected to the connections (5), and their properties.

9. A central control unit as claimed in claim 1, characterized in that it is integrated in one of the electronic apparatuses (8, 9, 10) and/or in a connection cable.

10. A network comprising electronic apparatuses (1, 2, 3) and control apparatuses (8, 9, 10), wherein the electronic apparatuses are coupled to the control apparatuses (8, 9, 10) via a central control unit (4) as claimed in claim 1.
